(19) United States
(12) Patent Application Publication
(10) Pub. No.: US 2003/0026284 A1
(43) Pub. Date: Feb. 6, 2003

(54) DIGITAL SIGNAL TRANSMISSION SYSTEM

(76) Inventors: WOLFGANG FRAAS, WOLFRATSHAUSEN (DE); KLAUS HUNLICH, NEUCHING (DE)

Correspondence Address: STAAS & HALSEY LLP, 700 11TH STREET, NW, SUITE 500, WASHINGTON, DC, 20001, US

(21) Appl. No.: 09/117,799

(22) PCT Filed: Feb. 3, 1997
(86) PCT No.: PCT/DE97/00205

(30) Foreign Application Priority Data
Feb. 6, 1998 (DE) 196 04 244.5

(51) Int. Cl. H04B 7/212

(52) U.S. Cl. 370/442; 370/395.1

(57) ABSTRACT

Transmission system for the transmission of digital signals, present in the form of time-division multiplex channels, between an exchange termination (ET) and a line termination (LT). Both the exchange termination (ET) and the line termination (LT) is respectively connected to a user interface (UNI) of an ATM network (ATMN) via a means (IWF) for converting time-division multiplex data into ATM cells or, respectively, from ATM cells into time-division multiplex data, whereby a virtual ATM channel is allocated to each time-division multiplex channel using this means.

The invention relates to a transmission system for transmission of time-multiplex-channel-type digital signals between a switching terminal device (exchange termination) and a line termination.

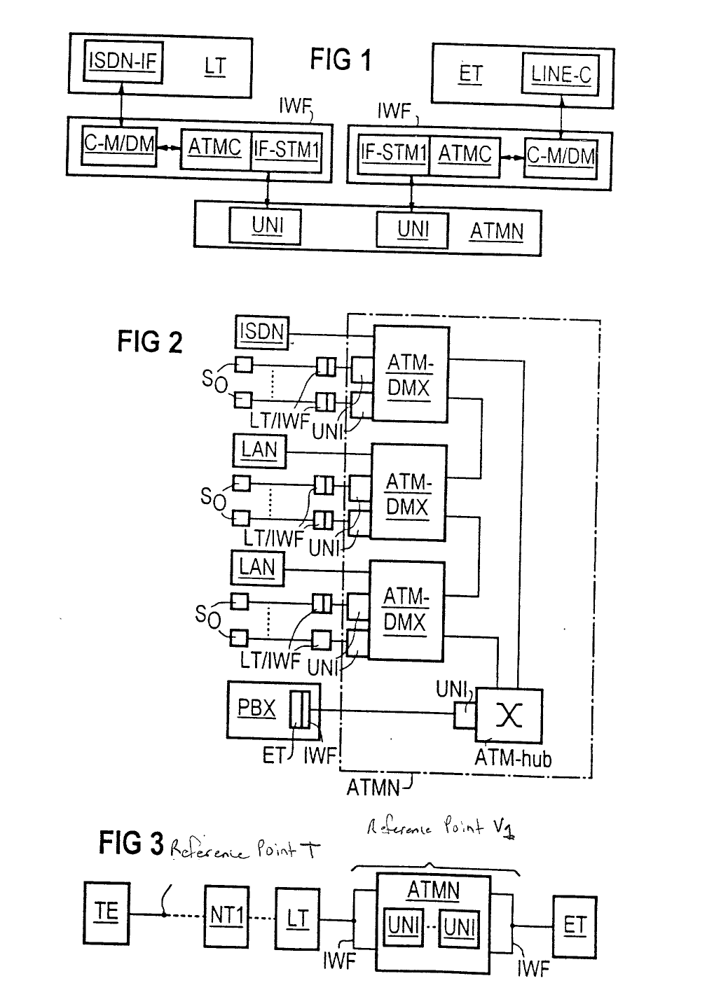

According to the terminology of the ITU-T G.960 standard (November 1993), “access digital section for ISDN basic rate access,” in particular pages 2 and 3, the invention thus relates to a data transmission at the V reference point. The data transmission at the V reference point takes place according to the ITU-T recommendation G.960, in particular page 2, FIG. 1/G.960 and page 3, FIG. 2/G.960 with associated specification, and also FIGS. 5/G.960 and 6/G.960 on page 9, with associated specification concerning functional elements between state automata. In practical application, the transmission takes place according to an industrial standard used by several semiconductor manufacturers, called IOM®-2 as an abbreviation of the expression “ISDN Oriented Modular Interface.” As can be seen in the company publication of the semiconductor manufacturer Siemens, “ICs for Communications, IOM®-2 Interface Reference Guide,” in particular chapter 2, “Global Picture,” pages 6 to 12, as well as FIG. 2 on page 8, time multiplex frames of 125 μm length are hereby transmitted. Such a frame is partitioned into sub-frames, called channels CH0, CH1, . . . , which are respectively allocated to a connection and thus form a connection frame. In the described IOM®-2 interface standard, such a connection frame contains, again in time-division multiplex form, four time-division multiplex channels, i.e., two useful channels B1 and B2, a monitor channel and a control information channel. In the IOM®-2 standard, these channels are chronologically arranged within the connection frame in such a way that the control information channel is transmitted last. The mentioned time-division multiplex channels each contain an 8-bit word. Consequently, four 8-bit words are transmitted quasi-simultaneously, i.e., within a connection frame cycle.

A transmission system for the transmission of digital signals between an exchange termination and a line termination is standardly part of a communication apparatus with a switching device and with a subscriber terminal means, whereby the switching device is coupled to the subscriber terminal means via an exchange termination and via a line termination. Such a communication apparatus serves to set up or, respectively, dismantle narrow-band communication connections between subscriber terminal means, and to enable a narrow-band communication (speech, audio, narrow-band video, text, facsimile, and/or data communication). Modern communication apparatuses hereby make use of a digital transmission technology, e.g. ISDN. In such communication apparatuses, it is required to connect the subscriber terminal units with the switching devices via lines. This standardly takes place via metallic line pairs. In a communication apparatus with many subscriber terminal units, an extensively branched line network is hereby required.

If the service provided to a subscriber terminal unit by a communication apparatus is to be moved from a location inside the communication apparatus to another location, a reconfiguration of the metallic connection lines between the switching device and the subscriber terminal unit is standardly required.

In many areas, nowadays a broadband communication apparatus, e.g. a local data network LAN, is additionally installed alongside a narrow-band communication apparatus. Such a local data network can for example also be constructed in the form of an emulated LAN on the basis of an ATM network. However, an ATM network is often installed independent of the construction of individual local data networks, in order to connect several local data networks.

ATM hereby stands for asynchronous transfer mode. ATM networks are described in (among other places) the book ATM Networks, Rainer Händl, Manfred N. Huber, Stefan Schröbder, Edison Wessley Publishing Company, 2nd ed., 1994, in particular in Chapter 4, pages 21 to 54. Within an ATM network, data, packed into ATM cells, are transmitted in a continuous in ATM cell stream [sic] via virtual channels of virtual paths. The transmission takes place in connection-oriented fashion. Subscribers can be connected via user interfaces, known as UNI (user-network interface), determined unambiguously by means of an identifier of the virtual path VPI (Virtual Path Identifier) and by an identifier VCI of the virtual channel (Virtual Channel Identifier).

The object of the present invention is to indicate a transmission system that enables, with an ATM network, the realization of a narrow-band communication system that is simple to install and simple to configure.

The invention achieves this object by means of a transmission system having the features of patent claim 1. Advantageous constructions are the subject matter of subclaims.

According to the invention, a transmission system is indicated for the transmission of digital signals, present in the form of time-division multiplex channels, between an exchange termination and a line termination, in which a means for connection to a user interface of an ATM network is respectively provided both for the exchange termination and for the line termination, said means serving for the conversion of the time-division multiplex data into ATM cells or, respectively, the conversion of the ATM cells into time-division multiplex data. Such a transmission system contributes to the solution of the object named above in that a virtual ATM channel is allocated to each time-division multiplex channel.

It is thereby enabled that the time-division multiplex data of the individual time-division multiplex channels can be inserted into an ATM cell stream, and that the cell stream can be distributed within the ATM network using administrative measures—namely, unambiguous allocation of a VPI address/VCI address of the ATM network to a time-division multiplex channel. Modifications of the distribution within the ATM network are very easily possible by this means, since, given for example a relocation of a subscriber from the region of a user interface of the ATM network into the region of another user interface of the ATM network, only the allocation of the VPI address/VCI address has to be changed. Moreover, by means of a transmission system as specified the problem of a physically caused range limitation between a switching device and a terminal apparatus is removed in a communication apparatus, since the user interface can be brought to a subscriber terminal unit or, respectively, to a switching device as needed.

If an ATM network is already present in a region in which a narrow-band communication apparatus is to be installed, the large-scale distribution of the information of the narrow-band communication can take place via the ATM network, and the distance between the network termination and the line termination can respectively be very small. If the ATM network for example offers the possibility of a connection between user interfaces that are arranged at a great distance from one another, subscriber terminal means that are correspondingly removed from one another can also be connected to a narrow-band switching apparatus. For example, by modification of the address allocations in the ATM network, calls coming into extensively branched company networks can be routed as needed (e.g., dependent on the time of day) to different terminal apparatuses, or line groups located at a distance from one another.

A development of the inventive transmission system is formed by a communication apparatus with a switching device for time-division multiplex digital signals, and having several exchange terminations. Several exchange terminations are hereby preferably connected to a single user interface of an ATM network. Dependent on the number of exchange terminations and the bandwidth provided by the user interface, at best all exchange terminations of the switching device can be connected to a single user interface of the ATM network.

A means for converting time-division multiplexing data and ATM cells preferably contains a channel multiplexer/demultiplexer for distributing the digital signals of the individual time-division multiplex channels to the respectively allocated ATM cells or, respectively, for the recuperation of the digital signals from the ATM cells and distribution into the allocated time-division multiplexing channels. Moreover, such a means provides an ATM converter for packing items of digital information obtained from the channel multiplexer/demultiplexer into ATM cells or, respectively, for unpacking ATM cells and giving the items of digital information contained therein to the channel multiplexer/demultiplexer, as well as for inserting ATM cells into a cell stream of the ATM network or, respectively, for removing ATM cells from this cell stream. In addition, a corresponding converter means preferably contains an interface, e.g. an STM1 interface, in order to pass an item of synchronization information of the time-division multiplex signals to the ATM network, or, respectively, to receive such information from the ATM network, evaluate it, and pass it to the ATM converter and to the channel multiplexer/demultiplexer.

A transmission system as described above ensures that items of information concerning the line status between a line termination and the allocated network terminal of a subscriber terminal means are transmitted to the exchange termination via the V reference point in the context of the standard time-division multiplex signaling. Moreover, the described construction of the conversion means ensures that the time-division multiplex signals are synchronized in the region of the subscriber terminal unit and in the region of the switching device.

In the following, the invention is explained in more detail on the basis of embodiments, with reference to the figures.

FIG. 1 shows, on the basis of a block switching diagram, an embodiment of an inventive transmission system;

FIG. 2 shows, on the basis of a block switching diagram, a communication apparatus as an example of the application of an inventive transmission system; and

FIG. 3 shows a transmission path between the subscriber terminal equipment and exchange termination according to ITU-T G.960, including an inventive transmission system in the region of the V₁ reference point.

FIG. 1 shows a block switching diagram of an inventive transmission system with an exchange termination ET and a line termination LT, respectively connected to a user interface UNI of an ATM network ATMN via a means IWF for converting time-division multiplex data and ATM cell data. The exchange termination ET shown contains a line driver circuit (line card) LINE-C, which for example provides an IOM®-2 interface to the line termination. The line termination LT contains an ISDN interface ISDN-IF, which provides a corresponding IOM®-2 interface to the exchange termination ET. The two converter means IWF shown respectively serve for the conversion of time-division multiplex data into ATM cell data, as well as of ATM cell data into time-division multiplex data, and respectively contain a channel multiplexer/demultiplexer C-M/DM, in order to distribute the digital signals of the individual time-division multiplex channels to the respectively allocated ATM cells, or, respectively, to recuperate them from the ATM cells and distribute them into the allocated time-division multiplex channels. Moreover, these means IWF respectively contain an ATM converter ATMC for packing items of digital information received from the channel multiplexer/demultiplexer C-M/DM in ATM cells or, respectively, for unpacking information from ATM cells and giving it to the channel multiplexer/demultiplexer C-M/DM, and for the insertion of ATM cells into a cell stream of the ATM network ATMN, via the respective user interface UNI, and for removing ATM cells from a cell stream of the ATM network ATMN. In addition, an interface IF-STM1 is contained in each means IWF, in order to pass an item of synchronization information of the time-division multiplex signals to the ATM network ATMN, or, respectively, to receive it from the ATM network ATMN, evaluate it, and pass it to the ATM converter ATMC and to the channel multiplexer/demultiplexer C-M-DM.

The design of the ATM network is inessential for the invention, and thus is not explained in detail here.

The means IFW for converting time-division multiplex data and ATM cells can be realized both as an independent means between the line termination LT and the allocated user interface UNI of the ATM network ATMN, and also as an input arrangement of the user interface UNI or as an output arrangement of the line termination LT. Correspondingly, it can also be realized as an output arrangement of an exchange termination ET, or as an intermediately connected arrangement.

FIG. 2 shows an inventive transmission system with a switching device PBX for setting up and dismantling narrow-band connections between communication terminal apparatuses (not shown), which can be connected via subscriber terminal means S₀ in the exemplary embodiment shown. The switching device PBX contains at least one exchange termination ET that is connected with a user interface UNI of the ATM network ATMN, likewise shown, via a means IWF for converting time-division multiplex data and ATM cell data. Among other things, the ATM network ATMN contains a switching node ATM-hub, and several ATM add/drop multiplexers ATM-DMX, to which user interfaces UNI, as well as other networks, such as e.g. local networks LAN or public narrow-band communication networks ISTN, can be connected, as is shown in FIG. 2. If, in the ATM network ATMN shown in FIG. 2, user interfaces UNI are represented as immediately following the switching nodes ATM-hub or, respectively, the ATM add/drop multiplexer ATM-DMX, this has no effect on the actual form of the realization of the ATM network, but rather merely illustrates the arrangement of the individual elements in relation to an information flow.

The subscriber terminal devices S₀. shown in FIG. 2 are respectively coupled to the user interfaces UNI via a line termination LT and a means IWF for converting time-division multiplex data and ATM cell data.

As can be seen from FIG. 2, a transmission system according to the invention enables a simple realization of a narrow-band communication apparatus, in which the installation of terminal lines is required only between user interfaces UNI of the ATM network ATMN and subscriber terminal units S₀, or, respectively, between the switching device PBX and a user interface UNI of the ATM network ATMN.

In FIG. 2, only one exchange termination ET, which is connected with a user interface UNI of the ATM network ATMN, is shown in the switching device PBX. Of course, for each line segment LT to be connected, and for trunk connections to global communication networks ISTN, an exchange termination ET can respectively be provided, which is connected to a user interface UNI of the ATM network ATMN via a separate user interface UNI, or is so connected in common with other exchange terminations ET.

As can be seen from the structure shown in FIG. 2, the allocation of individual exchange terminations ET and line terminations LT can be determined by the ATM network ATMN, so that a reconfiguration of individual line terminations LT is possible by means of simple administrative measures.

FIG. 3 shows a variant of the representation designated FIG. 1/G.960 in the above-mentioned standard ITU-T G.960, which variant connects a subscriber terminal apparatus TE (terminal equipment) to a network termination NT1 via a reference point T, couples this network terminal NT1 to a line termination LT via a digital transmission path (not shown in more detail), and connects this line termination LT to an exchange termination ET via a reference point V₁. In FIG. 3, in addition to the figure shown in ITU-T G.960, an inventive realization of the reference point V₁ with an ATM network ATMN with user interfaces UNI is shown, as well as with means IWF for connecting the line termination LT and the exchange termination ET to the ATM network ATMN, in order to convert the time-division multiplex data and the ATM cell data. respectively, to recuperate them from the ATM cells and distribute them into the allocated time-division multiplex channels, an ATM converter (ATMC) for packing items of digital information received from the channel multiplexer/demultiplexer (C-M/DM) into ATM cells or, respectively, for unpacking ATM cells and emitting the digital information contained therein to the channel multiplexer/demultiplexer (C-M/DM), and for insertion of ATM cells into a cell stream of the ATM network (ATMN) or, respectively, for removal of ATM cells from this cell stream, and contains an interface (IF-STM1) in order to pass an item of synchronization information of the time-division multiplex signals to the ATM network (ATMN) or, respectively, to receive this information from the ATM network (ATMN), evaluate it, and pass it to the ATM converter (ATMC) and to the channel multiplexer/demultiplexer (C-M/DM).

In the claims

1. [Transmission] A transmission system for [transmission of] transmitting digital signals, [present] in [the form of] time-division multiplex channels[,] between an exchange termination [(ET)] and a line termination [(LT), characterized in that] wherein both the exchange termination [(ET)] and the line termination [(LT)] respectively have a means [(IWF)] for [connection] connecting to a user interface [(UNI)] of an ATM network [(ATMN), in order to convert] and means for converting [the] time-division multiplex data into ATM cells, or[, respectively, to convert the] ATM cells into time-division multiplex data, [whereby] and a means for allocating a virtual ATM channel [is allocated] to each time-division multiplex channel.

2. [Transmission] A transmission system according to claim 1, [with] further comprising a switching device [(PBX)] for switching time-division multiplex digital signals [and with several] between a plurality of exchange terminations [(ET)], [characterized in that several] wherein the plurality of exchange terminations [(ET)] of the switching device are connected to a single user interface [(UNI)] of an ATM network [(ATMN)].

3. [Transmission] A transmission system according to claim 2, [characterized in that] wherein all exchange terminations [(ET)] of the switching device are connected to a single user interface [(UNI)] of [an] the ATM network [(ATMN)].

4. [Transmission] A transmission system according to claim 1 [one of the preceding claims], [characterized in that] wherein the means [(IWF)] for converting time-division multiplex data and ATM cells contains a channel multiplexer/demultiplexer [(CM/DM), in order to distribute the] for distributing digital signals of the individual time-division multiplex channels to the respectively allocated ATM cells, or[, respectively, to recuperate them] the digital signals from the ATM cells and distribute them into the allocated time-division multiplex channels; said system further comprising an ATM converter [(ATMC)] for packing items of digital information received from the channel multiplexer/demultiplexer [(C-M/DM)] into ATM cells or, respectively, for unpacking ATM cells and emitting the digital information contained therein to the channel multiplexer/demultiplexer [(C-M/DM)], and for [insertion of] inserting ATM cells from this cell stream, and [contains] an interface [(IF-STM1)] [in order to pass an item of] for passing synchronization information of the time-division multiplex signals to the ATM network [(ATMN)] or, respectively, to receive [this] synchronization information from the ATM network [(ATMN), evaluate it,] and pass it to the ATM converter [(ATMC)] and to the channel multiplexer/demultiplexer [(C-M/DM)].
